(19) United States
(12) Patent Application Publication
(10) Pub. No.: US 2022/0161078 A1
(43) Pub. Date: May 26, 2022

(54) METHOD AND COOLING ARRANGEMENT FOR COOLING AND DOUSING AN OVERHEATED BATTERY MODULE OF A HIGH-VOLTAGE BATTERY FOR A MOTOR VEHICLE

(71) Applicant: AUDI AG, Ingolstadt (DE)

(72) Inventors: Dirk BAEDER, Fellbach (DE); Michael GRABOWSKI, Ingolstadt (DE)

(73) Assignee: AUDI AG, Ingolstadt (DE)

(21) Appl. No.: 17/534,930

(22) Filed: Nov. 24, 2021

(30) Foreign Application Priority Data
Nov. 24, 2020 (DE) 102020131111.7

(51) Int. Cl. A62C 3/16; A62C 3/07; H01M 10/613; H01M 10/625; H01M 10/6568; H01M 10/6564

(52) U.S. Cl. CPC A62C 3/16; A62C 3/07; H01M 10/613; H01M 2200/00; H01M 10/6568; H01M 10/6564; H01M 2220/20; H01M 10/625

(57) ABSTRACT

A cooling arrangement for cooling at least one first and/or second battery module of a high-voltage battery for a motor vehicle. The cooling arrangement has a line arrangement which includes a feed connection, a first and second opening respectively associated with the first and second battery module, and which is designed as branched, so that a cooling medium provided at the feed connection can be led via a first line branch to the first outlet opening and via a second line branch to the second outlet opening and can be led selectively out of the first outlet opening or the second outlet opening.

### FIELD

The invention relates to a cooling arrangement for cooling at least one first and/or second battery module of a high-voltage battery for a motor vehicle, wherein the cooling arrangement comprises a line arrangement which includes a feed connection for coupling to a reservoir for a cooling medium for cooling the at least one first and/or second battery module and at least one outlet opening which is associated with at least the first and/or second battery module. The invention also relates to a corresponding method for cooling at least a first and/or a second battery module of a high-voltage battery for a motor vehicle.

### BACKGROUND

The present invention is in the field of high-voltage batteries, in particular for operating motor vehicles, for example, electric and/or hybrid vehicles. In such high-voltage batteries, under some circumstances, for example, in the case of an accident, so-called thermal propagation, i.e., a thermal runaway, can occur. Such a thermal runaway, for example, of a battery cell of such a high-voltage battery, initially manifests itself here in an increasing temperature of this battery cell which then, as a rule, without a countermeasure being taken, catches fire or explodes. According to the state of the art, in the case of such a thermal propagation of a high-voltage battery, the vehicle is doused or cooled with a large quantity of water. For example, after a vehicular accident of a battery-electric vehicle, in particular in the case of damaged and/or burning high-voltage battery, for safety reasons, the entire vehicle can be put in a container, and the vehicle in the container can be flooded with water. However, this requires a container, a fire truck for filling the container with water, and a crane for lifting the vehicle into the water-filled container.

Moreover, according to the current state of the art, the battery housing can also be flooded directly. However, this can be achieved only using a so-called fog nozzle by the fire department. Here, a fog nozzle is fired through the vehicle floor into the battery and same is flooded. Here it is disadvantageous that this flooding process is not optimized in terms of flow technology, and as a result the cooling performance is also not optimal. If the battery housing is filled up with water, then newly added water gushes anywhere out of the housing without its cooling effect having been optimally exploited. An additional disadvantage moreover consists in that the fire department must be specially trained, and, today, errors still commonly occur which in turn entail the risk that high voltage is present on the car body. Moreover, such a fog nozzle cannot be fired into the battery when the doors do not open after a crash, since the fog nozzle is fired from the passenger cabin from the top through the vehicle floor into the battery which as a rule is arranged under the vehicle floor. In addition, every fire department then must be equipped with such a fog nozzle which in addition is an expensive special piece of equipment.

Moreover, EP 3 204 978 B1 describes a battery system for a vehicle with slopes for distributing cooling water. The battery system is here designed so that water can penetrate from an external supply point through a site of the battery housing, in particular on the top side; under this inlet opening, an inclined plane is arranged, in which distributed openings are located. The water, distributed over the inclined plane, can thus penetrate into the battery through the openings. Thereby, an even water distribution over all the cells of the battery is to be provided. A disadvantage here is that in the case of flooding of the entire high-voltage battery, intact battery modules are also put under water. This results in an additional hazard and destruction of the modules. Due to the high water throughput, presumably serious damage is caused to the entire vehicle. Also, the water consumption is very high here, in order to be able to sufficiently cool the entire high-voltage battery. Such large water quantities can then in turn be provided only externally, for example, by the fire department. Consequently, it is, for example, not possible to rescue occupants already before the arrival of the fire department at the vehicle, since a propagating battery is located in the vehicle. This can endanger the life of occupants.

Moreover, DE 20 2007 011 578 U1 describes an arrangement with an air conditioning installation and an energy storage, wherein the circulation medium of the air conditioning installation can be led to the energy storage. More precisely, for this purpose, the energy storage can be surrounded by a wrapping such as, for example, an inflatable balloon, and the energy storage, the circulation medium and the wrapping constitute a heat exchanger. The circulation medium can here comprise carbon dioxide and be stored in particular in a pressurized container. During the outflow, the circulation medium can depressurize and as a result cool. Thereby, a cooling can be provided in order to preventively prevent a fire.

Moreover, DE 10 2016 200 368 A1 describes a battery system and a system for dousing or for preventing a fire of a battery module in a battery system, wherein a coolant circulation system is provided with at least one coolant container and with a coolant line, which is partially led through the battery module, wherein the coolant line is designed in such a manner that it has at least one emergency opening in the battery module which is closed by an actuation element designed as pressure-sensitive actuation element which opens at a pressure greater than a predetermined threshold value and unblocks the emergency opening. Moreover, the coolant container comprises a connection for a dousing agent hose or an interface for fastening a connection for a dousing agent hose. The battery module can also be composed of two submodules, wherein the coolant line within the housing of the submodules has at least one emergency opening. This allows a selective dousing of a submodule without repercussion on other unaffected submodules. Here, it is disadvantageous that, for dousing, the connection of an external dousing agent hose is again necessary, which in turn as a rule can only be carried out by the fire department. Moreover, here a single coolant line with corresponding openings is led through the battery module, whereby, in the case of dousing, a certain pressure drop along the line occurs, so that, for example, should be the two emergency openings for the dousing be open, a sufficiently high pressure may no longer be provided at the last opening in order to douse the submodule in question or generally to be able at all to open the emergency opening as a result of pressure.

In principle, the problem during the cooling or dousing of a high-voltage battery consists in that, because of the large quantities of dousing agent necessary for this purpose, dousing agent being also referred to as cooling medium in the context of the invention, this dousing agent must be provided via an external source, as a rule by the fire department, which, however, takes a long time and entails numerous additional problems which are described above. Although, by means of a motor vehicle-internal dousing agent reservoir, immediately upon the occurrence of such an emergency situation, the cooling or dousing could be started, in any case a large quantity of dousing agent cannot be accommodated, for reasons of installation space, by a motor vehicle-internal dousing agent reservoir, so that the dousing or cooling of a large-voltage battery with such a small quantity of dousing agent would be like a drop on hot stone, i.e., it would not have a perceivable effect. The motor vehicle-internal storage of larger quantities of dousing agent is not possible for reasons of installation space, and it would lead to an extremely high additional vehicle weight. Thus, previous measures for dousing or cooling battery modules of a high-voltage battery in the case of overheating or fire are relatively inefficient both in terms of time and also in terms of their effect.

### SUMMARY

The aim of the present invention therefore is to provide a method and a cooling arrangement which enable the most efficient cooling possible of at least one battery module of a high-voltage battery, in particular in the case of a thermal runaway or an imminent thermal runaway of the battery module.

This aim is achieved by a method and by a cooling arrangement with the features according to the respective independent claims. Advantageous embodiments of the invention are the subject matter of the dependent claims, the description and the figures.

According to a first aspect of the invention, the cooling arrangement for cooling at least one first and/or second battery module of a high-voltage battery for a motor vehicle includes a line arrangement which comprises a feed connection for coupling to a reservoir for a cooling medium for cooling the at least one first and/or second battery module, a first outlet opening which is associated with at least the first battery module, and a second outlet opening which is associated with at least the second battery module. Here, the line arrangement is designed to be branched and comprises at least a first line branch and a second line branch different from the first line branch. Moreover, the line arrangement is designed in such a manner that a cooling medium provided at the feed connection can be led via the first line branch to the first outlet opening and via the second line branch to the second outlet opening and can be led selectively out of the outlet opening and/or out of the second outlet opening.

Here, the invention immediately has multiple advantages. On the one hand, a targeted selective cooling of individual battery modules is enabled. For example, if only the first battery module is to be cooled, then the cooling medium can be fed in a targeted manner via the first outlet opening to the first battery module, without in the process a portion of the cooling medium being fed via the second outlet opening to the second battery module and vice versa. If the two battery modules are to be cooled, this can then also be brought about by feeding cooling medium via the two first and second outlet openings. The advantage here is that a targeted cooling of individual battery modules is clearly more effective than, for example, the flooding of the entire battery. Thereby, much less cooling medium is in fact necessary, which, for example, also enables the use of motor vehicle-internal cooling media which as a rule are present only in a very limited volume. A cooling of a certain battery module which, for example, is overheated, and for which, for example, there is a risk of thermal runaway, can thus occur particularly early and even before arrival of the fire department, which provides occupants of a motor vehicle with valuable rescue minutes. Nonetheless, for example, when the fire department has arrived, a coupling of a motor vehicle-external reservoir to the feed connection, for example, via a fire hose, is also possible, so that clearly larger quantities of cooling medium can then be fed in order to cool even more efficiently and effectively. However, in order to be able to achieve the most even possible cooling effect for the two battery modules, precisely also when multiple battery modules, for example, the first and the second battery modules, of the high-voltage battery are to be cooled, it is particularly advantageous that the line arrangement is designed as branched, so that, for example, the first and second outlet openings can be provided in different line branches. Thereby, the cooling medium is distributed over the two outlet openings almost evenly and there is no risk that an insufficient quantity of cooling medium is available at an outlet opening to be able to cool or douse the module in question, as would be the case if the outlet openings in question were provided along a common line. Thus, overall, a particularly efficient cooling arrangement can be provided, which enables a targeted cooling and extinction of individual battery modules of a high-voltage battery.

The branching of the line arrangement is accordingly designed so that the cooling medium led from the feed connection to the first outlet opening does not flood the second outlet opening, and cooling medium led from the feed connection to the second outlet opening does not flood the first outlet opening. The line arrangement should be designed so that it splits, starting from the feed connection, into at least the two line branches. The outlet openings in question, that is to say the first and second outlet openings, can then be arranged, for example, in each case in an end area of the line branches in question.

The line arrangement, in particular the line branches, can here be provided by hoses and/or tubes or the like, or they can also be integrated in a plate, for example, they can be implemented as cavity or as channels in the plate. Such a plate can also be designed, for example, as double-walled plate with a cavity provided between the plate walls, wherein this plate, in the arrangement according to intended use of the cooling arrangement on a high-voltage battery, extends over all the battery modules of the high-voltage battery, wherein the individual line branches can then be formed by respective passage bores, channels, or the like, extending from the cavity in the direction of the respective modules, in the plate wall facing the modules, which end with the respective outlet opening, which can be designed so that they can be opened and closed, for example, selectively, i.e., independently of one another.

Moreover, an outlet opening in question can be associated with precisely one battery module of the high-voltage battery. This is particularly advantageous since, as a result, each individual battery module can be cooled and/or doused in a targeted manner and separately independently of one another. However, it would also be conceivable that an individual outlet opening of a module group is associated with multiple battery modules. For example, the first outlet opening of a first module group can be associated with multiple first battery modules. The complexity in the design of the line arrangement can thereby be reduced. But in such a case it is however preferable that a module group with multiple battery modules includes as few battery modules as possible, for example, two or three modules, or at least a number of modules in the single-digit range.

In order to enable the selective feeding of the cooling medium to the at least one battery module which is associated with the outlet opening in question, a closure device, for example, in the form of a valve, can be arranged in a respective line branch. Such a closure device can, for example, be arranged directly in the region of the outlet opening and close or open said outlet opening as needed. In other words, the closure device can have at least an opened and a closed state, wherein the closing device interrupts a fluidic connection when said closure device is in the closed state and unblocks a fluidic connection when said closure device is in the opened state. The opening and closing of the closure device in question can occur, for example, under temperature control, so that, advantageously, the battery modules that are overheated, for which thermal runaway is imminent or may even already have taken place, can thus advantageously be cooled in a targeted manner.

In addition, the cooling arrangement can accordingly be designed to cool any number of battery modules of a high-voltage battery. For a respective battery module of the high-voltage battery or at least for a battery module group, a corresponding outlet opening of the line arrangement can be provided in an associated line branch which can be selectively opened or closed, for example, by appropriate actuation. Here, it is also not always in particular the first and second battery modules and the first and second outlet openings or the first and second line branches, but rather in general battery modules, outlet openings and line branches that are mentioned below. Moreover, it is preferable that the outlet openings are arranged with respect to the battery housing in such a manner that the cooling medium can be led via the outlet openings into an interior of the battery housing, so that the cooling medium can be brought in direct contact with at least one battery cell of the respective battery module. As already mentioned, the high-voltage battery preferably includes multiple battery modules. Each of these battery modules in turn can comprise multiple battery cells, for example, lithium ion cells. As a rule, these cells comprise a cell winding which is arranged in a cell housing, on which moreover two battery terminals are arranged, via which a cell voltage can be tapped externally. The individual battery cells are typically combined to a cell pack and can be accommodated, for example, in a module housing for forming a battery module. The individual battery modules in turn are arranged in a battery housing. Originally, it was assumed that a cooling or dousing of a high-voltage battery in the case of a thermal event should be carried out in such a manner that the dousing agent, for example, water, as a result of the high voltage, should not come in direct contact with the battery cells. Accordingly, to date, module housings or battery housings have been designed accordingly to be sealing, so that, during a flooding of the battery, the coolant or cooling medium at most comes in contact with the module housing but not in direct contact with the battery cells, in particular their cell terminals and wiring, in order to avoid a short circuit. However, it has emerged that, precisely in the case of a thermal runaway of a battery cell, the most effective manner of stopping this thermal propagation and preventing a fire or an explosion consists precisely in bringing a dousing agent, such as the cooling medium in the context of the present invention, in direct contact with such a battery cell, that is to say also in contact with its terminals. Therefore, it is thus preferable that the feeding of the cooling medium through the outlet openings in question to the battery modules occurs in such a manner that, in the end, the cooling medium is brought in direct contact with the battery cells in question contained by the battery module. If a battery module comprises, for example, a module housing which encloses the battery cells, then it is accordingly thus preferable that the outlet openings also open into the respective module housing, so that the cooling medium can be introduced not only into the interior of the battery housing but likewise also into the interior of the associated module housing. Thus, thereby, a thermal propagation of all the battery modules or of one battery module can be prevented most efficiently.

In an additional particularly advantageous embodiment of the invention, the cooling arrangement comprises a battery housing with a first housing chamber for receiving at least the first battery module or battery cells contained by the first battery module, and with a second housing chamber separated from the first housing chamber, for receiving at least the second battery module or battery cells contained by the second battery module, wherein the first outlet opening opens into the first housing chamber, and the second outlet opening opens into the second housing chamber, in particular wherein the first housing chamber is fluidically sealed with respect to the second housing chamber. Here too, it can again be provided that the battery housing for the high-voltage battery, depending on the number of battery modules present, also accordingly comprises multiple housing chambers which are associated with the respective preferably individual battery modules or also module groups. Here, such a housing chamber can be provided by an overall battery housing in which the individual battery modules can be inserted. However, the housing chambers can also be the module housings of the individual battery modules in which the battery cells of the battery modules are accommodated.

By means of such housing chambers, it can advantageously be brought about that, in a targeted manner, only an overheated module is cooled but the cooling medium then does not come in contact with other battery modules and their battery cells. This is particularly advantageous if, for example, a liquid cooling medium such as, for example, water, is used for cooling, since short circuits in intact modules can be prevented thereby. Indeed, such short circuits in turn can increase the probability of thermal propagation of the other initially still intact modules. However, the provision of such housing chambers has yet another great advantage, since the necessary volume of cooling medium, necessary for cooling an individual battery module, as a result of the accommodation of a battery module in such a chamber, can be kept at a minimum, since, for cooling this battery module, only the chamber with the battery module located therein has to be cooled with cooling medium and not the entire battery. By means of an additional fluidic sealing of the individual housing chambers, this effect can be further increased. For example, the individual housing chambers can be designed to be airtight and/or watertight. Thereby, for example, the introduced dousing water cannot have a negative effect on intact battery modules.

In an additional advantageous embodiment of the invention, arranged between the first housing chamber and the second housing chamber is a thermal insulation device for thermal insulation of the first and second housing chambers with respect to one another is arranged. Here too, multiple such thermal insulation devices can again be provided, which are arranged between the respective multiple housing chambers of the battery housing of the high-voltage battery. Such an insulation device can be designed, for example, as insulating plate or the like. By means of such a thermal insulation device it can thus be brought about that the battery modules are additionally thermally isolated with respect to one another, so that a flashover of a fire to intact battery modules is further impeded. By such a passive insulation, advantageously, time can also be saved, including when it is not possible to douse for the moment. In other words, for this protective measure, no water or other cooling medium is necessary. Important minutes can thus be gained for the rescue the occupants of a vehicle. Insulating materials which can be contained by the insulation device or which can provide said insulation device can be, for example, ceramics, fabrics, nonwoven materials, textiles, glass wool, metals, air gaps and so on. It is preferable that the insulation device is characterized by the smallest possible heat conduction coefficient, for example, in the order of magnitude of that of air, or less.

Moreover, it is advantageous if the cooling arrangement comprises a sensor device which is designed to acquire a first temperature associated with the first battery module and to acquire a second temperature associated with the second battery module, wherein the cooling arrangement moreover is designed to lead the cooling medium provided at the feed connection out through the first outlet opening only in the case in which the first temperature meets a predetermined criterion, and to lead it out through the second outlet opening only in the case in which the second temperature meets a predetermined criterion. Thereby, an overheated module can advantageously be cooled in a targeted manner, wherein it can be determined by means of the sensor device whether a battery module in question is overheated or not. As control parameter, for example, the temperature of the battery module, that is to say the first and/or second temperature, itself can be used, or, on the other hand, a temperature gradient or the like can also be used. Moreover, as temperature sensors, temperature sensors associated with the individual battery modules which are already incorporated in the battery can be used. With such temperature sensors, for example, the temperatures of the individual battery cells of the battery modules in question can be acquired separately, so that, via such temperature sensors, it can be determined exactly when a battery cell is thermally propagating, and which battery cell is thermally propagating and which module this battery cell is associated with. Preferably, here, an unblocking of the outlet opening in question already occurs when the temperature of a battery module, or the temperature of only one cell of the associated battery module already exceeds a limit value, preferably between 70 degree Celsius and 80 degree Celsius. A cell temperature of more than 70 degree Celsius to 80 degree Celsius indicates an imminent thermal event, so that thereby a particularly early cooling of the battery module in question can be initiated. Theoretically, it would be conceivable to associate in each case passive closure devices with the individual outlet openings. However, a controllable implementation of the unblocking of the outlet openings in question has the great advantage that, on one hand, thereby a selective actuation of the individual outlet openings can be implemented particularly simply, and, in addition, an unblocking can be implemented when any predeterminable temperature limit value, which in particular is less than 100 degree Celsius, is exceeded. Such closure devices, as already described above, here do not necessarily have to be arranged in the region of the respective outlet opening, but instead can be arranged anywhere in the line branch associated with the battery module in question.

In an additional advantageous embodiment of the invention, the first and second housing chambers each have an outflow opening, out of which cooling medium introduced into the first or second housing chamber can be led out of the first or second housing chamber. By the provision of such an outflow opening, defined flow conditions within the housing chamber can be provided, and, in addition, the throughput of cooling medium can also be increased. Thereby, the cooling performance can be increased tremendously. This is, for example, particularly advantageous when, at the feed connection, an external cooling medium source is connected, for example, by the fire department. Accordingly, a large quantity of cooling medium can be fed to the cooling arrangement by the fire department, so that just by providing an outflow opening in a respective housing chamber, the cooling medium throughput in the housing chamber with the battery module to be cooled can be increased tremendously. Such an outflow opening can, for example, be provided as permanently open, for example, in the form of a hole in the module housing and/or battery housing, or it can also be designed as an opening which is closed during normal operation, which, for example, opens only starting at a certain minimum pressure. Here, the outflow opening can also be designed so that it can be actuated in order to open said outflow opening starting at a certain pressure. However, it is preferable if said outflow opening is designed with a passive closure element, for example, with a relief valve. This tremendously simplifies the design of the cooling arrangement. In addition, it can also be achieved in that such an outflow opening is unblocked only when the cooling medium is introduced with corresponding pressure into the housing chamber in question, for example, when an external cooling medium source is connected at the feed connection, which allows a provision of the cooling medium at the feed connection with correspondingly high pressure, as, for example, in the case of a connection of a fire hose.

Moreover, it can also be provided that, for example, if the fire department is not yet on site, a housing chamber with an overheated battery module is first filled with a vehicle-internal cooling medium in order to cool the overheated battery module in question, wherein, in this case, the outflow opening still remains closed. It is only when the fire department arrives and can provide a clearly larger volume of cooling medium to the feed connection that the outflow opening opens correspondingly, so that the cooling performance for cooling the overheated battery module in question can be increased.

In an additional advantageous embodiment of the invention, the cooling arrangement comprises a battery housing for accommodating the first and second battery module, wherein the line arrangement comprises a main closure device arranged outside of the battery housing and designed to interrupt a fluidic connection between the feed connection and the first and second outlet opening in a closed state and to unblock it in an opened state. Such a main closure device can be provided, for example, in the form of a main valve. Thereby, it can advantageously be achieved that, during normal operation of the motor vehicle, the cooling medium, such as, for example, a liquid such as, for example, water, is kept away from the battery and stored outside of a battery housing, for example, in a motor vehicle-internal reservoir outside of the battery. Thereby, the risk of short circuit caused by a leak in the line arrangement is avoided. It is only in an emergency situation in which the battery module must be cooled that the main closure device can open and thus enable a flow of the cooling medium into the individual line branches, which can accordingly be arranged within the battery housing. Moreover, the main valve or the main closure device is preferably arranged in a position relative to the intended direction of flow of the cooling medium before the branching of the line arrangement, for example, in a main line from the reservoir or from the feed connection to the individual line branches, so that only a single main valve or a single main closure device is necessary. Thereby, the complexity can be reduced to a minimum. Naturally, it would also be conceivable to arrange such a respective main closure device in portions of the individual line branches arranged outside the battery.

In an additional advantageous design of the invention, the cooling arrangement comprises at least one connection device for connecting a motor vehicle-external reservoir, in particular a fire hose, which can be or is coupled to the feed connection or is provided by the feed connection. Thus, thereby, advantageously, for example, a fire hose can be coupled to the feed connection, whereby, precisely if multiple battery modules have to be cooled, a particularly efficient cooling can be provided, since, by means of an external reservoir as can be provided by the fire department, a considerably larger quantity of cooling medium can be used for cooling the battery modules. Here, it is moreover particularly advantageous if multiple such connection devices are provided for connecting a motor vehicle-external reservoir, for example, in different positions of the motor vehicle which includes the cooling arrangement. In other words, such connection devices can be provided around the vehicle, for example, on the driver side and on the passenger side, in the trunk region, in the front region or the like. Thereby, precisely in the case of an accident, in which some sides of a motor vehicle can be accessed only with difficulty, the probability that at least one of the connection devices can be reached easily by the fire department for connecting a hose can be increased.

In an additional advantageous embodiment of the invention, the cooling arrangement includes the reservoir for the cooling medium, which is designed as a motor vehicle-internal reservoir and which is or can be fluidically coupled to the feed connection. This embodiment can also advantageously be combined with the above-described embodiment according to which at least one connection device is provided for the connection of a motor vehicle-external reservoir. In fact, by means of a motor vehicle-internal reservoir which is filled in particular with a cooling medium, a cooling of at least one battery module can already be provided when the fire department is not yet on site, whereby important additional rescue minutes can be provided for rescuing occupants. When the fire department then finally arrives, it can provide, at the connection device, additional cooling medium, for example, an additional quantity of cooling medium, for example, water, in order to continue the cooling. Not only water but other cooling media are suitable as cooling medium, precisely as cooling medium for the motor vehicle-internal reservoir. Preferably, in the reservoir, a cooling medium from the following group is accommodated: carbon dioxide, nitrogen or cooling medium including primarily water. The carbon dioxide and/or the nitrogen can here be accommodated in the reservoir, particularly in liquid and/or gaseous form, preferably at high pressure. In particular, the motor vehicle which includes the cooling arrangement can also comprise multiple different motor vehicle-internal reservoirs which are or can be fluidically coupled to the feed connection and in which different cooling media can be provided. In particular, in this way motor vehicle-internal cooling media can also be used, which otherwise, during normal operation of the motor vehicle, have an entirely different function. Such other cooling media can be, for example, cooling water, which flows through a cooling device for cooling the high-voltage battery during normal operation. Alternatively or additionally, the cooling medium can also be wiper fluid which is usually used for the windshield wiper installation in the front and rear regions. If the motor vehicle is, for example, a hybrid vehicle with a combustion engine, then the cooling medium can also be water from a water container for water injection according to the EU7 emission standard. If the motor vehicle comprises, for example, a fuel cell, then the motor vehicle typically also includes a water collection container for the fuel cell. Such water collected in such a water collection container can also be used as cooling medium. Theoretically, as additional cooling media, gear oil or motor oil are also available. All in all, by cooling media normally used otherwise, in total a relatively large volume of cooling medium can be provided, which, in an emergency situation, can advantageously also be used for cooling at least one battery module. In other words, the cooling arrangement can comprise a motor vehicle-internal reservoir from which the cooling medium contained in the reservoir is fed, for example, by means of a pump, to the feed connection in a first operating mode which represents an emergency operation, wherein the reservoir is associated with a device of the motor vehicle which is different from the high-voltage battery and which can be supplied with the cooling medium from the reservoir in a second operating mode different from the first and/or by means of which the cooling medium in the reservoir can be provided. Here, the device can be one of the devices already mentioned above. It can also be provided that the device is a windshield wiper installation of the motor vehicle and the reservoir is a wiper fluid container and the cooling medium is wiper fluid, and/or is a coolant circuit for cooling an engine of the motor vehicle and/or a vehicle interior, wherein the reservoir is a cooling water compensation container and the cooling medium is a coolant, and/or is a water injection device for water injection for a combustion engine of the motor vehicle, wherein the reservoir is a water container of the water injection device and the cooling medium is water for the water injection, and/or is a fuel cell and the reservoir is a water collection container for collecting the water released as reaction product by the fuel cell during the operation and the cooling medium is the released water.

This is particularly advantageous precisely in combination with the local selective cooling possibility provided by the invention that for the targeted cooling of individual battery modules or of only a single battery module, only very little cooling medium is also necessary, so that this small quantity can be covered without problem by the liquids present in any case in the motor vehicle. However, it is also particularly advantageous if a motor vehicle-internal reservoir is provided, for example, specifically for purposes of cooling or dousing at least one battery module in such an emergency situation, and which reservoir contains liquid carbon dioxide or liquid nitrogen. For this purpose, the reservoir can be designed as a corresponding low-pressure container, in order to keep the carbon dioxide or the nitrogen in the liquid state. Indeed, a particularly efficient expansion cooling can be advantageously provided by liquid carbon dioxide or liquid nitrogen. If the liquid nitrogen or the liquid carbon dioxide is expanded, then an extremely large temperature lowering can be achieved thereby, for example, in the case of liquid carbon dioxide, to, for example, −70 degree Celsius, and, in the case of liquid nitrogen, to even lower temperatures.

Accordingly, in a particularly advantageous embodiment of the invention, the line arrangement comprises at least one expansion device, for example, an expansion valve, which is designed to expand and thereby cool the cooling medium as it flows through the expansion device, in particular to a temperature of less than at most −20 degree Celsius, preferably at most

−70 degree Celsius. Thereby, advantageously, freezing of individual battery modules can even be achieved. Although this then leads to irreversible damage to the battery module in question, it is maximally efficient with regard to the interruption of the chemical reaction which occurs in the case of a thermal runaway of a battery cell. It is effective in particular since, according to the Arrhenius principle, a lowering of the temperature by 10 degree Celsius is associated with a halving of the reaction rate. The Arrhenius equation here is:

$$k = A * {e}^{- \frac{{E}_{A}}{R * T}} .$$

Here k represents the reaction rate, A a system constant, R the universal gas constant, T the temperature, and EA the activation energy. For a cooling from, for example, 80 degree Celsius to −150 degree Celsius, this means a reduction of the reaction rate to 0.01 percent. Thereby, the thermal runaway is decreased by a very large order of magnitude, and effectively more time is provided for rescuing occupants even before the fire department arrives. Thus, advantageously, by the cooling arrangement, individual battery modules can be cooled and frozen locally. At the same time, it becomes possible here that, to the extent possible, no negative influencing of adjacent intact battery modules occurs.

Thus, this results in the possibility of locally freezing with cooling agents a thermal propagation of individual battery cells immediately after detection. The reaction rate can here be reduced one hundredfold. An effective increase of the rescue time, until the fire department arrives or while the fire department is already working on the rescue, can also be provided. An additional positive side effect moreover consists in that nitrogen, that is to say N₂, and carbon dioxide, that is to say CO₂, are extinguishing gases which, in addition, have a flame smothering effect.

Moreover, according to a second aspect, the invention relates to a cooling arrangement for cooling at least one battery module of a high-voltage battery, which comprises a line arrangement which comprises a feed connection for coupling to a reservoir for a cooling medium for cooling the at least one battery module, and an outlet opening which is associated with the at least one battery module, wherein the line arrangement is designed to lead a cooling medium provided at the feed connection to the first outlet opening. Here, the line arrangement moreover comprises at least one expansion device which is designed to expand the cooling medium as it flows through the at least one expansion device, wherein the cooling arrangement comprises a battery housing for accommodating the at least one battery module, and wherein the outlet opening is arranged with respect to the battery housing in such a manner that the cooling medium expanded by the at least one expansion device can be led via the outlet opening into an interior of the battery housing, so that the cooling medium can be brought in direct contact with at least one battery cell of the battery module.

This results in advantages, as already described regarding the embodiments, in particular the last embodiment, of the cooling arrangement according to the first aspect of the invention. By means of such an expansion device, an expansion cooling for cooling at least one battery module can thus advantageously be provided, by means of which extremely low temperatures can be achieved, in particular if, for example, nitrogen or carbon dioxide is used as cooling medium. The use of an inert gas, for example, helium, neon, argon, krypton, xenon, is also conceivable as are any mixtures of the mentioned gases. In particular, as described above, freezing of a battery module can be achieved thereby. Apart from that, the mentioned components of the cooling arrangement according to the second aspect of the invention, that is to say, for example, the feed connection, the outlet opening, the line arrangement as well as also other optional components such as, for example, the battery modules, the high-voltage battery, the battery housing, can be designed as already described in the context of the first aspect of the invention. In addition, the features described concerning the first aspect of the invention also enable the development of the cooling arrangement according to the second aspect of the invention by corresponding features, and vice versa.

Moreover, a motor vehicle with a cooling arrangement according to the first or second aspect of the invention or one of its embodiments can also be considered to be part of the invention. The motor vehicle according to the invention is preferably designed as motor vehicle, in particular as passenger car vehicle or truck, or as a passenger van or motorbike.

According to an additional embodiment of the invention, it is advantageous if the motor vehicle comprises a refrigerant circuit with a refrigerant and a refrigerating compressor, wherein the reservoir is part of the refrigerant circuit, wherein the cooling arrangement is designed to feed the refrigerant as the cooling medium to the feed connection in a first operating mode which represents an emergency operation, and, in a second operating mode different from the first operating mode, to bring a cooling medium of the motor vehicle in a cooling medium circuit of the motor vehicle to the right temperature by means of the refrigerant circuit. Advantageously, the refrigerant circuit here provides a cooling medium which is simultaneously suitable for cooling and/or dousing at least one battery module and which, in addition, is very suitable for an expansion cooling, as described above, for example, carbon dioxide. It is precisely with the optional combination of the local module-specific cooling and/or dousing possibility that an immediate and particularly effective cooling and dousing can be provided.

In addition, according to the first aspect, the invention also relates to a method for cooling at least one first and/or second battery module of a high-voltage battery for a motor vehicle by means of a cooling arrangement which comprises a line arrangement which comprises a feed connection for coupling to a reservoir for a cooling medium for cooling the at least one first and/or second battery module, a first outlet opening which is associated at least with the first battery module, and a second outlet opening which is associated at least with the second battery module. The line arrangement is here designed as branched and comprises a first line branch and a second line branch different from the first line branch, wherein a cooling medium provided at the feed connection is led via the first line branch to the first outlet opening and via the second line branch to the second outlet opening, and, as a function of at least one parameter, for example, the temperature of a battery module, is selectively led out of the first outlet opening and/or the second outlet opening. The parameter can thus be the temperature of the battery module in question and/or also a temperature gradient or also a different control variable. Such a different control variable is here preferably configured to characterize a critical state of at least one battery cell of a battery module. The advantages mentioned for the cooling arrangement according to the first aspect of the invention and its embodiments likewise apply to the method according to the invention.

Moreover, according to the second aspect, the invention also relates to a method for cooling at least one battery module of a high-voltage battery by means of a cooling arrangement which comprises a line arrangement which comprises a feed connection for coupling to a reservoir for a cooling medium for cooling the at least one battery module and an outlet opening which is associated with the at least one battery module, wherein by means of the line arrangement, a coolant provided at the feed connection is led to the first outlet opening. Here, the line arrangement moreover comprises an expansion device which expands the cooling medium as it flows through the expansion device. Moreover, the cooling medium expanded by the expansion device is led via the outlet opening into an interior of a battery housing for accommodating the at least one battery module, so that the cooling medium is brought in direct contact with at least one battery cell of the battery module.

The advantages mentioned in connection with the cooling arrangement described according to the second aspect of the invention also apply here likewise to the method according to the invention according to this second aspect of the invention.

The invention also relates to developments of the method according to the invention according to the first and second aspects of the invention, which comprise features as already described in connection with the developments of the cooling arrangements according to the invention according to the first and second aspect of the invention. For this reason, the corresponding developments of the methods according to the invention according to the first and second aspects of the invention are not described again here.

The invention also includes the combinations of the features of the described embodiments. The invention also includes implementations which each comprise a combination of the features of multiple embodiments among the described embodiments, to the extent that the embodiments have not been described as mutually exclusive.

### BRIEF DESCRIPTION OF THE FIGURES

Below, embodiment examples of the invention are described. For this purpose, the drawings show:

FIG. 1 a diagrammatic exploded representation of a cooling arrangement according to a first embodiment example of the invention;

FIG. 2 a diagrammatic exploded representation of a cooling arrangement according to a second embodiment example of the invention;

FIG. 3 a diagrammatic and perspective representation of a cooling arrangement according to a third embodiment example of the invention; and

FIG. 4 a diagrammatic representation of a high-voltage battery with multiple battery modules for a cooling arrangement according to an additional embodiment example of the invention.

### DETAILED DESCRIPTION

The embodiment examples described below are preferred embodiments of the invention. In the embodiment examples, the described components of the embodiments each represent single features of the invention to be considered independently of one another, which in each case also further develop the invention independently of one another. Therefore, the disclosure is intended to also include combinations other than the represented combinations of the features of the embodiments. Moreover, the described embodiments can also be completed by additional features of the already described features.

In the figures, identical reference numerals each denote functionally equivalent elements.

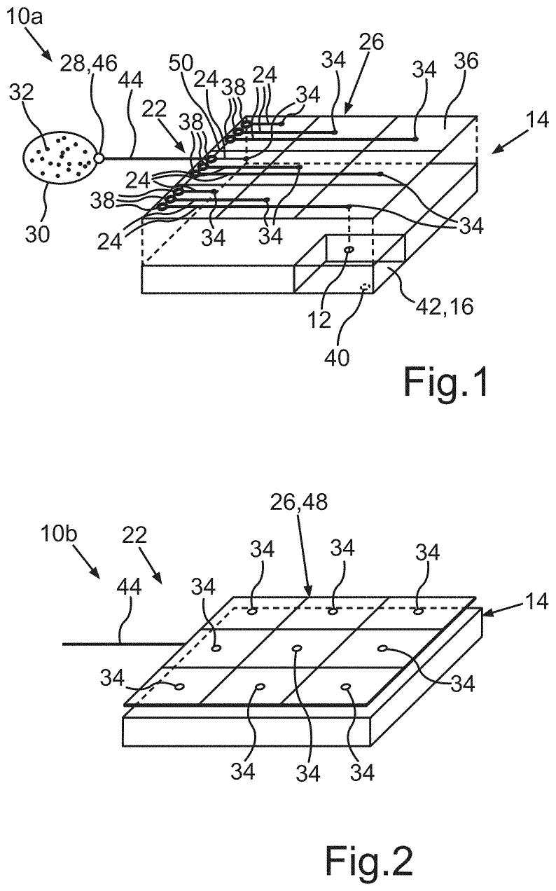

FIG. 1 shows a diagrammatic exploded representation of a cooling arrangement 10a according to a first embodiment example of the invention. The cooling arrangement 10a here is provided for cooling at least one battery module 12 of a high-voltage battery 14. The high-voltage battery 14 and the at least one battery module 12 are represented only diagrammatically in this example. A somewhat more realistic image is shown, for example, in FIG. 4 which shows a diagrammatic and perspective representation of a high-voltage battery 14 with multiple battery modules 12, of which just one is provided with a reference numeral for reasons of clarity. The individual battery modules 12 can here each include multiple battery cells, for example, lithium ion cells, which are arranged in a cell pack. This cell pack in turn can be arranged in a module housing 16 of the battery module 12. Moreover, the battery modules 12 can be arranged in a battery housing 18 (see FIG. 4) which is represented only diagrammatically and with dotted lines in FIG. 4 and which can comprise a housing cover 20.

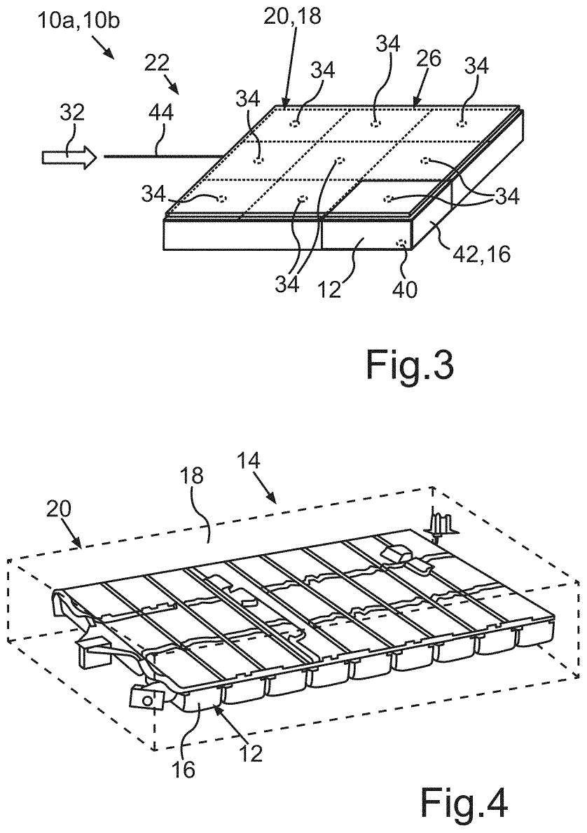

In FIG. 1, the high-voltage battery 14 and an individual battery module 12 are each diagrammatically illustrated as a cuboid. The cooling arrangement 10a moreover comprises a line arrangement 22. The line arrangement 22 is designed with extensive branching and accordingly comprises multiple line branches 24 associated with the individual battery modules 12. These line branches 24 can in particular be part of a distribution device 26 of the cooling arrangement 10a. The cooling arrangement 10a moreover comprises a feed connection 28 for coupling to a reservoir 30 for a cooling medium 32. The reservoir 30 can be, for example, a motor vehicle-internal reservoir or it can also be provided externally to the motor vehicle, for example, by a fire department. In other words, the feed connection 28 can be part of the motor vehicle in which the cooling arrangement 10a is to be used as intended. At this feed connection 28, a motor vehicle-internal reservoir 30 can then be connected and/or this feed connection can also be coupled, for example, to a fire hose which then connects the corresponding feed connection to a motor vehicle-external reservoir 30. Finally, via this feed connection 28, a cooling medium 32 can be fed to the line arrangement 22 and led via the distribution device 26 in a distributed manner to the individual battery modules 12. In order to enable a local and selective module cooling, one line branch 24 per battery module 12 is preferably provided, which, in addition, comprises an outlet opening 34 associated with the battery module 12 in question. To illustrate this association, the distribution device 26 in FIG. 1 is diagrammatically subdivided into individual square segments 36, of which only one is provided with reference numerals for reasons of clarity. In other words, these segments 36 do not necessarily have to be provided physically, rather they simply illustrate the subdivision of the distribution device 26 into individual segments 36 associated with the respective battery modules 12. Here, advantageously, a respective outlet opening 34 is arranged directly above the associated battery module 12. In particular, this outlet opening 34 which is associated with a respective battery module 12 opens into the interior of the module housing 16 (compare FIG. 4). In this way, it is possible to feed the cooling medium 32 to the battery module 12 in question in such a manner that it can be brought in direct contact with the battery cells contained by the battery module 12. It is precisely in the case of a thermally propagating battery cell that thereby a slowing or even an interruption of the chemical reaction occurring in the battery cell is most effectively provided. The high-voltage battery 14 thus includes multiple battery modules 12 which are located directly under the distribution device 26 which in turn provides individual dousing device segments, that is to say the segments 36. A respective dousing device segment 36 in turn has at least one outlet opening 34 which, for example, can be designed as a water introduction site. These individual outlet openings 34 thus open into the individual battery modules 12. One outlet opening per battery module 12 is particularly advantageous, since thereby a particularly high resolution of the local dousing possibilities can be provided. However, a clustering of multiple battery modules 12 per dousing device segment 36 would also be possible. In other words, not only a single battery module 12 but also, for example, a group with multiple battery modules can be associated with a dousing device segment 36. Moreover, it is preferable that a high-voltage battery cover, such as, for example, the housing cover 20 (compare FIG. 4), closes from the top, as also illustrated, for example, in FIG. 3. In other words, advantageously the distribution device 26 is located between such a battery cover 20 and the battery modules 12. In order then to enable a targeted cooling of an overheated battery module 12, in that a portion of the cooling medium 32 is fed to this battery module 12 while the rest of the battery modules 12 remain largely untouched thereby, a closure device, for example, in the form of a sequence valve 38, is moreover associated with each line branch 24. In this example, at the beginning of a respective line branch 34, the sequence valves 38 are arranged in the direction of flow of the cooling medium 32 according to the intended use. In principle, these sequence valves can be arranged anywhere at any site in a respective line branch 34, for example, also in the region of the respective outlet openings 34. By means of these sequence valves 38, the inflow of the cooling medium 32 can advantageously be steered into the respective line branches 24 separately and independently of one another. Accordingly, these sequence valves are also preferably designed as controllable valves.

Moreover, a sensor device, not explicitly represented here, which is designed to acquire the temperature of the respective battery modules 12, can also be provided. For this purpose, the sensor device can include temperature sensors, which, according to the state of the art, can in any case already measure with spatial resolution the temperatures for each battery cell and can be incorporated in the corresponding battery modules. Thus, when the temperature sensors register that a critical temperature increase occurs in one or more battery modules 12, then, immediately after this registration and still before the fire department arrives and also before or at the same time as the triggering of an emergency call, for example, liquid media present in the motor vehicle, for example, cooling water, wiping water, gear oil, motor oil, water in the water container for a water injection in the case of a combustion engine, water in the water collection container of a fuel cell, if present, can be used as cooling medium 32 for local battery module cooling or dousing. The local use of the vehicle-internal media as cooling medium 32 is provided by the selective opening of the outlet openings in question. Here, it can be provided that these outlet openings, in addition to the sequence valves 38 present, can be opened or closed, in order to unblock or to block the introduction of the cooling medium 32 in question into the respective battery modules 12. However, it can also be provided that these outlet openings are provided only as non-closable openings and that the control of the discharge of the cooling medium 32 through these outlet openings 34 occurs only via the sequence valves 38. Accordingly, the cooling medium 32 is then fed to the selected battery modules 12 in question and they are thereby cooled or doused.

Moreover, an outlet 40, preferably one per battery module 12, can also be provided, in particular a closable outlet 40 which can be opened, for example, in order to increase the water throughput or in general the throughput of the cooling medium, or to achieve a filling up of the battery module 12. The outlet 40 can here also be designed to be passive, for example, it can open automatically at a correspondingly high pressure or a correspondingly high temperature, or it can also be actuated actively. The outlet 40 can be designed so that it can reversibly be opened and closed or so that it can be opened irreversibly, for example, as a bursting element or bursting membrane.

In order to be able to cool individual battery modules 12 in a targeted manner, in particular without effects on adjacent intact battery modules 12, it is moreover preferable if the respective battery modules 12 are arranged in an associated housing chamber 42 which can be provided diagrammatically in FIG. 1 as the wall of the respective cuboid which illustrates the battery module 12. This housing chamber 42 can also be provided in a particularly simple way by the module housing 16 described with regard to FIG. 4, in which the cell packs are arranged. The aforementioned outlet 40 can then, for example, be arranged in a wall of such a module housing 16.

The terms “top” and “bottom” in the present case relate to the installation position according to the intended use, of the cooling arrangement 10a and of the battery 14 in a motor vehicle. With regard to this installation position according to intended use it is moreover preferable that the outlet 40 is arranged not as represented in FIG. 1 on a bottom side of the housing chamber 40 or of the module housing 16 but instead preferably on a side wall of the module housing 16 which is different from a top side and a bottom side of the module housing, wherein the top side of the module housing 16 faces the distribution device 26. The provision of the outlet 40 in a side wall of the module housing 16 has the advantage that the outlet 40 is not blocked by the battery cells arranged in the module housing 16. The battery cells are in fact typically arranged on the floor of the module housing 16 in question, that is to say on its bottom side, in order to connect them via this bottom side to a battery cooling for cooling the battery 14 during normal operation.

Thus if one wishes to allow a certain housing chamber 15 to fill up in order to cool the battery module 12 contained therein, or if not much cooling medium 32 is initially available, for example, before the arrival of the fire department, then the associated outlet 40 can at first remain closed. When the fire department arrives and provides additional cooling medium at the feed connection 28, then accordingly, for increasing the throughflow quantity and for increasing the efficiency of the cooling, the outlet 40 in question can be opened. In order to enable the connection of a motor vehicle-external reservoir 30, it is also advantageous to provide at least one connection on the overall vehicle, which is or can be coupled to the feed connection 28. In the case in which the fire department arrives at the vehicle, the fire department, via this connection on the overall vehicle, can then introduce water or another cooling medium into the distribution device 26 via the feed line 44 which fluidically connects in particular the feed connection 28 to the distribution device 26 and douse the propagating battery modules 12. Such an exterior connection on the motor vehicle is then accordingly accessible from outside the motor vehicle. To prevent misuse, such exterior connections can comprise a safety device which, for example, can be provided by means of a relief valve which unblocks the fluidic connection between the exterior connection and the feed connection only when a certain minimum pressure has been exceeded. This certain minimum pressure is measured so that said minimum pressure is exceeded without problem by an average water pressure normally provided via a fire hose.

Moreover, it is particularly advantageous if the individual housing chambers 42, that is to say, for example, the respective module housings 16, are designed to be watertight, so that the introduced dousing water cannot negatively affect intact battery modules 12. In addition, it is exceedingly advantageous if the battery modules 12 are additionally thermally insulated with respect to one another, so that a flashover of the fire to intact battery modules is further impeded.

Moreover, the local actuation can technically be implemented via the already-described sequence valves 38 in the distribution device 26 which in a targeted manner actuates the feed into the respective dousing device segment 36. The water or in general the cooling medium 32 is then led from the outlet opening 34, for example, from the water introduction site, into the battery module 12 in question. The sequence valves 34 can be arranged inside or outside the battery housing 18. Naturally, it is also possible to simultaneously open multiple sequence valves 38, for example, in order to preventatively flood and cool adjacent battery modules 12, so as to delay a jumping over of the fire. In other words, for example, as a function of the acquired module temperature, if it is detected that a battery module 12 is overheated and possibly a thermal event is imminent, then, by corresponding actuation of the associated sequence valve 38, this module 12 can be cooled in a targeted manner with the cooling medium 32 by feeding it into the module housing 16. In addition, in this case, the sequence valves 38 associated with the adjacent battery modules 12 can also be opened in order to preventatively flood these battery modules 12, even if their module temperature has not yet exceeded a predetermined limit value or even if no thermal event has been otherwise predicted for these battery modules 12. Thereby, the safety can be further increased.

Moreover, the high-voltage battery 14 with the described cooling arrangement 10a can be installed in a motor vehicle in such a manner that the high-voltage battery 14 with the cooling arrangement 10a, at least with the distribution device 26, is located under the vehicle undercarriage. Between the vehicle undercarriage and the high-voltage battery 14 with the distribution device 26, an air gap of predetermined width is here preferably located. It can be provided here that the cooling arrangement 10a is moreover designed so that, for example, this air gap can also be doused. For this purpose, one or more additional line branches can be contained by the line arrangement 22, which are associated, for example, with this air gap and via which quite analogously cooling medium 32 can be introduced in a targeted and selective manner into this air gap.

As described, water 32 can be used as cooling medium, which, for example, can be provided externally by the fire department or which can also be provided by internal water supplies. Alternatively or additionally, it is also possible that nitrogen and/or carbon dioxide is used as cooling medium 32. It can be stored as liquefied or highly compressed gas in the reservoir 30 which then preferably represents a motor vehicle-internal reservoir 30. In this connection, it is additionally particularly advantageous if the cooling arrangement 10a moreover comprises an expansion valve 46. This can be provided, for example, in the region of the feed connection 28 as illustrated, for example, in FIG. 1, or else at any other site of the line arrangement 22. It is advantageous, for example, if the expansion valve 46 is provided in a region before the branching of the line arrangement 22, since for the expansion of the cooling medium 32 only a single expansion valve 46 is then sufficient, and since the line branches can then be designed for lower pressures and therefore more simply. However, alternatively, expansion valves 46 can also be arranged in a respective line branch 24. For example, the sequence valves 34 could also be designed as such expansion valves, or the expansion valves can be provided in the region of the respective outlet openings 34. This advantageously enables a particularly local and efficient cooling with minimal cooling losses.

By expansion of this highly compressed cooling medium 32, advantageously, freezing of at least one thermally propagating high-voltage battery module 12 can be provided. For freezing, a so-called expansion cooling device is used, which includes the mentioned at least one expansion valve 46. Moreover, the expansion cooling can be fed via a storage container, the mentioned reservoir 30, with liquefied or highly compressed gas which is preferably not combustible, thus, for example, nitrogen or carbon dioxide, or by the vehicle-internal refrigerant circuit. For this purpose, the refrigerating compressor present in the refrigerant circuit in the vehicle can also be used simultaneously when, for example, CO₂ is used as refrigerant for air conditioning systems. Alternatively, a separate compressor unit could also be integrated for this purpose in the vehicle. Such a compressor unit can then also be part of the described cooling arrangement 10a. The liquefied or highly compressed working gas is then led as cooling medium 32 in turn via valves and feed lines to a local point in the high-voltage battery 14, as already described in detail for a general cooling medium 32. This working gas can then be expanded, for example, in the region of the outlet openings 34 via an expansion valve 46 arranged there into the battery module 12 in question, or it can be provided as expanded gas already expanded earlier for example, by the expansion valve 46 arranged in the region of the feed connection 28, in order to lead said working gas then to the respective desired outlet openings 34. As a result of the expansion of the working gas, a significant temperature drop occurs. By computation, using the ideal gas law, at pressures of already 4 bar, for example, of the working gas initially stored under pressure, one gets approximately −70 degree Celsius, when said working gas is expanded to a normal pressure of 1 bar. At an initial pressure of the working gas of 80 bar, for example, one gets approximately −180 degree Celsius, wherein the exact values are dependent on the gas used and the valves. Accordingly, it is advantageous to provide the highest possible gas or fluid pressure in the reservoir 30, which is preferably approximately 80 bar, or at least greater than 10 bar.

It is particularly advantageous if there is in each case one expansion valve 46 per battery module 12, which is then arranged in the line associated with the battery module 12 or in the associated line branch 24, for example, directly at the outlet opening 34, since, in the case of a detected thermal runaway with a temperature greater than 80 degree Celsius, a significant temperature lowering, in particular below −100 degree Celsius, can immediately be adjusted in the battery module 12 in question by means of the refrigerant. Thereby, the thermal runaway can be slowed in a very large order of magnitude. Although one expansion valve 46 per battery module 12 is also advantageous, here too a clustering of multiple battery modules 12 per expansion device segment 36 would also be possible.

Thus, if the temperature sensors, which according to the state of the art today already measure temperatures with spatial resolution for each battery cell, in turn register that a critical temperature increase occurs, the refrigerant could be used for freezing the battery immediately before the arrival of the fire department. In this case as well, optionally an outlet 40 can be provided or opened in the battery module 12, in particular in the module housing 16, as already described, in order to possibly increase the refrigerant throughput or in order to achieve a filling up of the cell or of the module 12. In this case as well, the outlet 40 can again be designed to be passive, for example, as a bursting valve or a bursting membrane, or in general to be controlled by pressure and/or temperature, or instead it can also be designed so that it can be actuated actively.

Here too, it is conceivable again that the fire department arrives at the vehicle and then feeds additional refrigerant via the external connection on the overall vehicle, so that, via the feed line 44, the freezing of the battery module 12 can occur in a lasting manner.

In this example too, in a particularly advantageous embodiment, the battery modules in question can be again designed to be fluidtight and gastight, so that the introduced gaseous refrigerant cannot negatively affect intact battery modules 12. Here again, it is also conceivable to open multiple sequence valves 38 simultaneously, for example, in order to preventatively flood and cool adjacent battery modules 12 with the gaseous refrigerant in order to delay a jumping over of the fire.

In addition, the individual line branches 24 or in general the distribution device 26 can be provided by conduit pipes and/or conduits or the like. Alternatively, these lines of the distribution device 26 can also be integrated in a plate. This is represented diagrammatically in FIG. 2.

FIG. 2 in turn shows a diagrammatic representation of a cooling arrangement 10b according to an additional embodiment example of the invention. In this example, the distribution device 26 is now provided by a plate 48, in which the lines explicitly represented in FIG. 1, that is to say the line branches 24 as well as the transverse line 50 connecting the individual line branches 24 to one another, can be integrated and are therefore no longer explicitly represented in FIG. 2. Accordingly, on the bottom side, this plate can comprise the outlet openings 34 in question, which open into the respective associated battery modules 12. For the rest, the cooling arrangement 10b can also be designed as described with regard to FIG. 1. The mentioned closure devices and valves can also be integrated, as described with regard to FIG. 1, in the individual lines, even if said lines run in the plate 48.

It is precisely in connection with the aforementioned expansion cooling that it can additionally be provided that, in this example, the feeding of the refrigerant to the individual battery modules 12 cannot controlled separately and independently of one another. For example, the refrigerant for freezing the entire high-voltage battery 14 in the detected emergency case can also be simply introduced into all the battery modules 12. However, a selective feed line is nevertheless preferable, since it enables a targeted use precisely in the case of a small refrigerant reserve.

FIG. 3 then shows a diagrammatic representation of a cooling arrangement 10a, 10b with a high-voltage battery 14, wherein the cooling arrangement 10a, 10b can be designed as described with regard to FIG. 1 and/or FIG. 2. In addition, in this representation, the aforementioned housing cover 20 is also represented, which can be considered to be part of a battery housing 18 and which, in the present example, is arranged on the distribution device 26. In other words, the distribution device 26 is integrated in the battery 14. The feeding of the cooling medium 42 occurs via the feed line 44. However, the distribution device 26 does not necessarily have to be integrated in the battery 14. An arrangement of the distribution device 26 outside of the battery 14 would also be conceivable, for example, over the battery 14, i.e., over the housing 20, with corresponding feed lines into the high-voltage battery 14, which can then be led correspondingly through the housing cover 20.

Overall, the examples show how, by the invention, a cooling arrangement can be provided which enables a local dousing of battery modules of a high-voltage battery in the case of thermal propagation, as well as expansion cooling for a thermally propagating high-voltage battery for freezing the battery fire. The invention and its embodiments then advantageously make it possible to cool or douse a thermal propagation of individual battery cells locally using vehicle-internal media immediately after detection. By local dousing, the water or cooling medium requirement for this purpose is exceedingly low. By means of a thermal insulation and a watertight design of individual battery modules, the spreading of fire can be inhibited, which, overall, leads to exceedingly low damage to the overall vehicle by such a cooling or dousing maneuver. In addition, intact battery cells are not unnecessarily negatively influenced by dousing water or cooling medium, and an effective increase of the rescue time can be provided, even before the fire department arrives. Moreover, increased safety for the fire department and individuals present in the vicinity and for infrastructures can be ensured thereby. In addition, for the implementation, only a small intervention in the existing vehicle structure is necessary, so that only low additional costs are generated here. Moreover, the invention also has a high potential for cross-sector standards and standardization. It is precisely when using expansion cooling that it additionally becomes possible to freeze individual battery cells and modules locally with refrigerant immediately after detection, whereby the reaction rate can be reduced a hundredfold. This leads to an effective increase of the rescue time before the fire department arrives or when the fire department is already working on the rescue operation. Since nitrogen and carbon dioxide are primarily extinguishing gases, their flame-smothering effect can additionally be used.

1. A cooling arrangement for cooling at least one first and/or second battery module of a high-voltage battery for a motor vehicle, wherein the cooling arrangement comprises:
a line arrangement which includes:
a feed connection for coupling to a reservoir for a cooling medium for cooling the at least one first and/or second battery module;
a first outlet opening which is associated with at least the first battery module, and
a second outlet opening which is associated with at least the second battery module,
wherein
the line arrangement is designed as branched and comprises at least a first line branch and a second line branch different from the first line branch, wherein the line arrangement is designed in such a manner that a cooling medium provided at the feed connection can be led via the first line branch to the first outlet opening and via the second line branch to the second outlet opening and selectively led out of the first outlet opening and/or the second outlet opening.

2. The cooling arrangement according to claim 1,
wherein
the cooling arrangement comprises a battery housing with a first housing chamber for accommodating at least the first battery module or battery cells contained by the first battery module, and with a second housing chamber separated from the first housing chamber, for accommodating at least the second battery module or battery cells contained by the second battery module, wherein the first outlet opening opens into the first housing chamber and wherein the second outlet opening opens into the second housing chamber, in particular wherein the first housing chamber is fluidically sealed with respect to the second housing chamber.

3. The cooling arrangement according to claim 2,
wherein,
between the first housing chamber and the second housing chamber, a thermal insulation device is arranged for thermal insulation of the first and second housing chambers from one another.

4. The cooling arrangement according to claim 2,
wherein
the first and second housing chambers each comprise an outflow opening from which cooling medium introduced into the first or second housing chamber can be led out of the first or second housing chamber.

5. The cooling arrangement according to claim 1,
wherein
the cooling arrangement comprises a battery housing for accommodating the first and second battery module, wherein the line arrangement comprises a main closure device arranged outside of the battery housing, which is designed to interrupt a fluidic connection between the feed connection and the first and second outlet opening in a closed state and to unblock it in an opened state.

6. The cooling arrangement according to claim 1,
wherein
the cooling arrangement comprises at least one connection device for connecting a motor vehicle-external reservoir, in particular via a fire hose, which can be or is coupled to the feed connection or is provided by the feed connection.

7. The cooling arrangement according to claim 1,
wherein
the cooling arrangement includes the reservoir for the cooling medium, which is designed as a motor vehicle-internal reservoir and which is or can be fluidically coupled to the feed connection, wherein in particular at least one cooling medium from the following group is accommodated in the reservoir:
carbon dioxide;
nitrogen;
a cooling medium comprising primarily water.

8. The cooling arrangement according to claim 1,
wherein
the line arrangement comprises at least one expansion device which is designed to expand and thereby cool the cooling medium as it flows through the at least one expansion device, in particular to a temperature of less than at most −20° Celsius, preferably at most −70° Celsius.

9. A motor vehicle with a cooling arrangement according claim 1, in particular wherein the motor vehicle comprises a refrigerant circuit with a refrigerant and a refrigerating compressor, wherein the reservoir is part of the refrigerant circuit, wherein the cooling arrangement is designed to feed the refrigerant as the cooling medium to the feed connection in a first operating mode which represents an emergency operation, and to bring a coolant of the motor vehicle in a coolant circuit of the motor vehicle to the right temperature by the coolant circuit in a second operating mode different from the first operating mode.

10. A method for cooling at least one first and/or second battery module of a high-voltage battery for a motor vehicle by at least one cooling arrangement which comprises:
a line arrangement which includes:
a feed connection for coupling to a reservoir for a cooling medium for cooling the at least one first and/or second battery module;
a first outlet opening which is associated with at least the first battery module, and
a second outlet opening which is associated with at least the second battery module,
wherein
the line arrangement is designed as branched and comprises at least a first line branch and a second line branch different from the first line branch, wherein a cooling medium provided at the feed connection is led via the first line branch to the first outlet opening and via the second line branch to the second outlet opening and selectively led out of the first outlet opening and/or the second outlet opening as a function of at least one parameter.

11. The cooling arrangement according to claim 3,
wherein
the first and second housing chambers each comprise an outflow opening from which cooling medium introduced into the first or second housing chamber can be led out of the first or second housing chamber.

12. The cooling arrangement according to claim 2,
wherein
the cooling arrangement comprises a battery housing for accommodating the first and second battery module, wherein the line arrangement comprises a main closure device arranged outside of the battery housing, which is designed to interrupt a fluidic connection between the feed connection and the first and second outlet opening in a closed state and to unblock it in an opened state.

13. The cooling arrangement according to claim 3,
wherein
the cooling arrangement comprises a battery housing for accommodating the first and second battery module, wherein the line arrangement comprises a main closure device arranged outside of the battery housing, which is designed to interrupt a fluidic connection between the feed connection and the first and second outlet opening in a closed state and to unblock it in an opened state.

14. The cooling arrangement according to claim 4,
wherein
the cooling arrangement comprises a battery housing for accommodating the first and second battery module, wherein the line arrangement comprises a main closure device arranged outside of the battery housing, which is designed to interrupt a fluidic connection between the feed connection and the first and second outlet opening in a closed state and to unblock it in an opened state.

15. The cooling arrangement according to claim 2,
wherein
the cooling arrangement comprises at least one connection device for connecting a motor vehicle-external reservoir, in particular via a fire hose, which can be or is coupled to the feed connection or is provided by the feed connection.

16. The cooling arrangement according to claim 3,
wherein
the cooling arrangement comprises at least one connection device for connecting a motor vehicle-external reservoir, in particular via a fire hose, which can be or is coupled to the feed connection or is provided by the feed connection.

17. The cooling arrangement according to claim 4,
wherein
the cooling arrangement comprises at least one connection device for connecting a motor vehicle-external reservoir, in particular via a fire hose, which can be or is coupled to the feed connection or is provided by the feed connection.

18. The cooling arrangement according to claim 5,
wherein
the cooling arrangement comprises at least one connection device for connecting a motor vehicle-external reservoir, in particular via a fire hose, which can be or is coupled to the feed connection or is provided by the feed connection.

19. The cooling arrangement according to claim 2,
wherein
the cooling arrangement includes the reservoir for the cooling medium, which is designed as a motor vehicle-internal reservoir and which is or can be fluidically coupled to the feed connection (28), wherein in particular at least one cooling medium from the following group is accommodated in the reservoir:
carbon dioxide;
nitrogen;
a cooling medium comprising primarily water.

20. The cooling arrangement according to claim 3,
wherein
the cooling arrangement includes the reservoir for the cooling medium, which is designed as a motor vehicle-internal reservoir and which is or can be fluidically coupled to the feed connection, wherein in particular at least one cooling medium from the following group is accommodated in the reservoir:
carbon dioxide;
nitrogen;
a cooling medium comprising primarily water.
